(19) United States
(12) Patent Application Publication
(10) Pub. No.: US 2026/0243577 A1
(43) Pub. Date: Aug. 20, 2026

(54) A RIDER ASSIST SYSTEM FOR A VEHICLE AND A METHOD THEREOF

(71) Applicant: TVS MOTOR COMPANY LIMITED, Chennai (IN)

(72) Inventors: Dipanjan Mazumdar, Chennai (IN); Valavanur Umasankar Kalpana, Chennai (IN)

(73) Assignee: TVS MOTOR COMPANY LIMITED, Chennai (IN)

(21) Appl. No.: 18/870,016

(22) PCT Filed: Oct. 14, 2022
(86) PCT No.: PCT/IN2022/050918

§ 371 Date: Nov. 27, 2024

(30) Foreign Application Priority Data
May 30, 2022 (IN) 202241030951

(51) Int. Cl. G01C 21/34; B62J 50/21; B62J 50/22

(52) U.S. Cl. CPC G01C 21/3453; B62J 50/22; B62J 50/225

(57) ABSTRACT

A rider assist system for a vehicle includes a communication module in communication with an external communication device and a display module for displaying information to a rider. A control unit receives information from the external communication device, determines whether a pre-defined riding event out of a set of pre-defined riding events occurs after a pre-defined interval, receives and displays on the display module, a primary set of information irrespective of the pre-defined riding event occurring, and receives and displays on the display module, a secondary set of information corresponding to the pre-defined riding event before the pre-defined interval, in addition to the primary set of information, when it is determined that the pre-defined riding event occurs after the pre-defined interval. Herein, the secondary set of information has a larger data size than the primary set of information.

### FIELD OF THE INVENTION

The present invention relates to a rider assist system for a vehicle. More particularly, the present invention relates to a system and a method for assisting a rider for a vehicle.

### BACKGROUND OF THE INVENTION

With the prominent shift in the vehicle paradigm from internal combustion vehicles to electric vehicles, and developments in the rider assist technologies, the user interface and the connected features are progressing exponentially. These user interfaces or rider assist systems are unique to a vehicle and are expected to act as a built-in assistant system. The most prominent utility of these built-in assistant systems is to provide the rider with route information and navigation whenever it is necessary. The existing conventional rider assist systems available in the market are based on expensive Operating System (OS) based systems to display the information. Not only are the OS based system more difficult to configure but are also more cost and processor capacity intensive. Further, the conventional systems are configured to always provide a large set of information to the rider, which may act as a distraction to the rider while riding, which may lead to loss of attention of the driver. This loss of attention may in severe cases, lead to road accidents. Furthermore, said OS based system require regular supply of current to perform its operation and display the same on the screen. These conventional OS based system may put extra pressure on the batteries, especially in the case of the electric vehicles and hybrid electric vehicles, where saving power is a critical issue.

Since the conventional systems are feature heavy OS based systems, their user friendliness remains an issue. Further, these conventional systems require data transfer of a very large size at all times, which in erratic network conditions, may lead to inaccuracies in the system. A large part of this data also consists of unnecessary information that might not be always required by the rider.

Alternatively, if the rider uses an external device connected to the vehicle for navigation, the readability and handling of such an external device is a cause for inconvenience to the rider. Further, the readability of route information data is presented in a way that is difficult for the rider to read and decipher while riding the vehicle.

Thus, there is a need in the art for a rider assist system for a vehicle and a method thereof, which addresses at least the aforementioned problems.

### SUMMARY OF THE INVENTION

In one aspect, the present invention relates to a rider assist system for a vehicle. The system has a communication module in communication with an external communication device, and a display module to display information to a rider of the vehicle. The display module is in communication with a control unit. The control unit receives information from the external communication device through the communication module; and determines, based on the information received, whether a pre-defined riding event out of a set of pre-defined riding events will occur after a pre-defined interval. The control unit receives a primary set of information from the external communication device and displays the primary set of information on the display module, irrespective of the pre-defined riding event occurring. Further, the control unit receives a secondary set of information from the external communication device and displays the secondary set of information on the display module, corresponding to the pre-defined riding event before the pre-defined interval, in addition to the primary set of information, if it is determined that the pre-defined riding event will occur after the pre-defined interval, wherein the secondary set of information has a larger data size than the primary set of information.

In an embodiment of the invention, the information received by the control unit has navigation data from the external communication device.

In a further embodiment of the invention, the pre-defined interval includes a pre-defined distance and/or a pre-defined time. In an embodiment, the control unit is configured to determine whether the pre-defined riding event out of the set of pre-defined riding events will occur after a pre-defined distance. In another embodiment, the control unit is configured to determine whether the pre-defined riding event out of the set of pre-defined riding events will occur after a pre-defined time.

In a further embodiment of the invention, the control unit is configured to determine each of the pre-defined riding events on the route of the rider based on the origin and destination selected by the rider and display the secondary set of information corresponding to the specific pre-defined riding event before the pre-defined interval, in addition to the primary set of information.

In another embodiment of the invention, the control unit is configured to determine each of the pre-defined riding events on the route of the rider based on the origin and destination selected by the rider, and receive information corresponding to each of the pre-defined riding events before the start of the ride.

In a further embodiment of the invention, the display module has a Thin-Film Transistor (TFT) display panel configured to be provided on the vehicle, or a wearable device.

In another embodiment of the invention, the external communication device is a smart phone or a tablet device capable of being carried by the rider.

In another embodiment of the invention, the secondary set of information has full map images corresponding to the pre-defined riding event that is occurring after the pre-defined interval.

In a further embodiment of the invention, the primary set of information has directional arrows to guide the rider for navigating the vehicle through the one or more pre-defined riding events that are along a path of the origin and destination.

In a further embodiment of the invention, the communication module has a wireless interface module configured to be in communication with the external communication device over a wireless network.

In another embodiment of the invention, the vehicle is a saddle type vehicle, the display panel is provided on an instrument panel on a handlebar of the vehicle, and the saddle type vehicle is provided with a visor for providing frontal coverage to the display panel.

In a further embodiment of the invention, the secondary set of information further has one or more of an audio feedback to a wearable device, a visual feedback on a display panel or visor of the wearable device, or a haptic feedback on a handlebar of the vehicle.

In another embodiment of the invention, the control unit is configured to monitor whether one or more vehicle parameters lie within a pre-defined range corresponding to the origin and destination selected by the rider. In an embodiment, the one or more vehicle parameters includes availability of battery capacity, health of sensors and actuators, health of power train and tyre pressure.

In a further embodiment of the invention, if the one or more vehicle parameters do not lie within the pre-defined range, the control unit is configured to suggest one or more solutions enroute the destination selected by the rider.

In a further embodiment of the invention, the control unit is capable of optimising the route from origin to destination selected by the rider based on at least distance, duration, and the one or more vehicle parameters.

In another aspect, the present invention relates to a method for assisting a rider for a vehicle. The method has the steps of receiving, by a control unit, information from an external communication device through a communication module. At the next step, the control unit determines, based on the information received, whether a pre-defined riding event out of a set of pre-defined riding events will occur after a pre-defined interval. Further, at the next step, the control unit receives from the external communication device and displaying on a display module, a primary set of information irrespective of the pre-defined riding event occurring; and receives from the external communication device and displaying on the display module, a secondary set of information corresponding to the pre-defined riding event before the pre-defined interval, in addition to the primary set of information, if it is determined that the pre-defined riding event will occur after the pre-defined interval. Herein, the secondary set of information has a larger data size than the primary set of information.

In an embodiment of the invention, the information received by the control unit has navigation data from the external communication device.

In a further embodiment of the invention, the method has the step of the step of monitoring whether one or more vehicle parameters lie within a pre-defined range corresponding to the origin and destination selected by the rider. In an embodiment, the one or more vehicle parameters are availability of battery capacity, health of sensors and actuators, health of power train and tyre pressure.

In a further embodiment of the invention, if the one or more vehicle parameters do not lie within the pre-defined range, the method has the step of suggesting one or more solutions enroute the destination selected by the rider.

In a further embodiment of the invention, the method has the step of the step of optimising the route from origin to destination selected by the rider based on at least pre-set favourite destinations, nearby attractions, and the one or more vehicle parameters.

In another aspect, the present invention relates to a display module for a rider assist system. The display module has a Thin-Film Transistor (TFT) display panel configured for displaying data to a rider. The display module is in communication with a control unit. The control unit receives information from the external communication device through the communication module; and determines, based on the information received, whether a pre-defined riding event out of a set of pre-defined riding events will occur after a pre-defined interval. The control unit receives a primary set of information from the external communication device and displays the primary set of information on the display module, irrespective of the pre-defined riding event occurring. Further, the control unit receives a secondary set of information from the external communication device and displays the secondary set of information on the display module corresponding to the pre-defined riding event before the pre-defined interval, in addition to the primary set of information, if it is determined that the pre-defined riding event will occur after the pre-defined interval, wherein the secondary set of information has a larger data size than the primary set of information.

In a further embodiment of the invention, the control unit is configured to determine each of the pre-defined riding events on the route of the rider based on the origin and destination selected by the rider and display the secondary set of information corresponding to the specific pre-defined riding event before the pre-defined interval, in addition to the primary set of information.

In another embodiment of the invention, the control unit is configured to determine each of the pre-defined riding events on the route of the rider based on the origin and destination selected by the rider, and receive information corresponding to each of the pre-defined riding events before the start of the ride.

In another aspect, the present invention is directed towards a wearable device for a rider assist system. The wearable device has a display module with a Thin-Film Transistor (TFT) display panel configured for displaying data to a rider. The display module is in communication with a control unit. The control unit receives information from the external communication device through the communication module; and determines, based on the information received, whether a pre-defined riding event out of a set of pre-defined riding events will occur after a pre-defined interval. The control unit receives a primary set of information from the external communication device and displays the primary set of information on the display module, irrespective of the pre-defined riding event occurring. Further, the control unit receives a secondary set of information from the external communication device and displays the secondary set of information on the display module, corresponding to the pre-defined riding event before the pre-defined interval, in addition to the primary set of information, if it is determined that the pre-defined riding event will occur after the pre-defined interval, wherein the secondary set of information has a larger data size than the primary set of information.

In an embodiment of the invention, the wearable device is worn by the rider on the head and the display panel is provided on a visor of the wearable device.

### BRIEF DESCRIPTION OF THE DRAWINGS

Reference will be made to embodiments of the invention, examples of which may be illustrated in accompanying figures. These figures are intended to be illustrative, not limiting. Although the invention is generally described in context of these embodiments, it should be understood that it is not intended to limit the scope of the invention to these particular embodiments.

FIG. 1 illustrates a rider assist system, in accordance with an embodiment of the present invention.

FIG. 2 illustrates the rider assist system in operation, in accordance with an embodiment of the present invention.

FIG. 3 illustrates the method steps involved in a method for assisting a rider, in accordance with an embodiment of the present invention.

FIGS. 4A, 4B and 4B further illustrates the method steps involved in the method for assisting a rider, in operation, in accordance with an embodiment of the present invention.

FIG. 5 illustrates a display panel on a saddle type vehicle, in accordance with an embodiment of the present invention.

### DETAILED DESCRIPTION OF THE INVENTION

The present invention generally relates a rider assist system for a vehicle a method thereof, a display module and a wearable device.

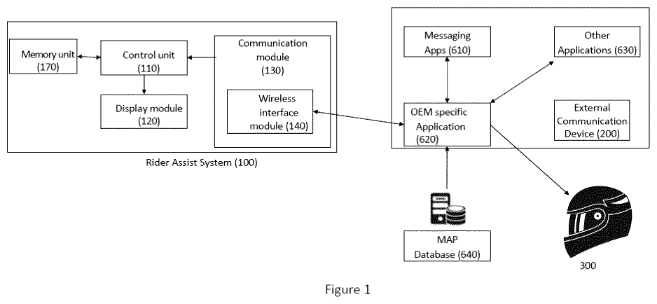

FIG. 1 illustrates a rider assist system 100 in accordance with an embodiment of the invention. As illustrated, the rider assist system 100 comprises a communication module 130. The communication module 130 is configured to be in communication with an external communication device 200. In an embodiment, the external communication device 200 comprises a smart phone or a tablet device capable of being carried by the rider. It is to be understood that the external communication device 200 is equipped with network capabilities to be connected to a map database 640 over a VoLTE, LTE, 3G type of network or the like. The external communication device 200 is thus capable of downloading data from the map database 640 as per requirement. The external communication device 200 is further equipped with messaging apps 610, Original Equipment Manufacturer (OEM) specific application 620 which are designed and provided in relation to the vehicle that the rider is riding, and other applications 630 as per requirement.

In an embodiment, the communication module 130 in communication with the external communication device 200, comprises a wireless interface module 140. The wireless interface module 140 facilitates the communication of the communication module 130 with the external communication device 200 over a wireless network such as Bluetooth, WiFi, or the like.

The rider assist system 100 further comprises a display module 120 that is configured to display information to a rider of the vehicle. The display module 120 is in communication with the communication module 130. The display module 120 is in further communication with a control unit 110. Thus, the information downloaded by the external communication device 200 from the map database 640 is communicated to the control unit 110 via the communication module 130 of the rider assist system 100. The control unit 110 is thus capable of processing the data received from the external communication device 200.

As mentioned earlier, the control unit 110 is configured to receive information from the external communication device 200 through the communication module 130. In an embodiment, the information received by the control unit 110 comprises navigation data from the external communication device 200. The control unit 110 is further configured to determine whether a pre-defined riding event out of a set of pre-defined riding events will occur after a pre-defined interval. In operation, once a rider chooses an origin and a destination, the set of pre-defined riding events comprises of junctions, intersections, flyovers, underpass, exits, or the like that lie between the origin and the destination chosen by the rider.

In an embodiment, the pre-defined interval comprises of a pre-defined distance and/or a pre-defined time. Thus, in an embodiment, the control unit 110 is configured to determine whether the pre-defined riding event out of the set of pre-defined riding events will occur after a pre-defined distance. In an alternate embodiment, the control unit 110 is configured to determine whether the pre-defined riding event out of the set of pre-defined riding events will occur after a pre-defined time.

The control unit 110 is further configured to receive a primary set of information, from the external communication device 200 and display the primary set of information on the display module 120, irrespective of the pre-defined riding event occurring. Thus, in operation, the primary set of information will be received or downloaded from the external communication device 200 and displayed on the display module 120 throughout the route of the rider, and under all riding conditions. If it is determined that the pre-defined riding event will occur after the pre-defined interval, the control unit 110 is further configured to receive a secondary set of information from the external communication device 200 and display the secondary set of information on the display module 120, corresponding to the pre-defined riding event before the pre-defined interval, in addition to the primary set of information. Herein, the secondary set of information has a larger data size than the primary set of information. In an embodiment, the display module 120 has a Thin-Film Transistor (TFT) display panel configured to be provided on the vehicle, or a wearable device 300. In that, the display module 120 being a TFT based module, has no processing capabilities, and thus the rider assist system 100 is provided for the vehicle without requiring an Operating System to facilitate the working of the rider assist system.

In an embodiment, the primary set of information comprises directional arrows to guide the rider for navigating the vehicle through the one or more pre-defined riding events that are along a path of the origin and destination. While, the secondary set of the information comprises full map images corresponding to the pre-defined riding event that is occurring after the pre-defined interval. In operation, once the rider has selected the origin and the destination, along the route, the pictorial arrows are always displayed for navigation during the transit from the origin to the destination. When a pre-defined riding event like a flyover, junction, exit, or the like is about to occur after a pre-defined distance and/or a pre-defined time, the full map images are displayed on the display panel along with the pictorial arrows to allow better and more accurate navigation. As a result, the full map images are only displayed to the rider before the pre-defined riding event is about to occur, thus displaying only necessary information to the rider. This limiting of information to be displayed also allows for the data to be handled without requiring an operating system.

In an embodiment, the control unit 110 is configured to determine each of the pre-defined riding events on the route of the rider based on the origin and destination selected by the rider and display the secondary set of information corresponding to the specific pre-defined riding event before the pre-defined interval, in addition to the primary set of information. This means that the receiving of the information from the external communication device 200 takes place in real time along the route of the rider, that is the primary set of information is received/downloaded from the external communication device 200 and displayed at all times, while the secondary set of information is received/downloaded from the external communication device 200 and displayed only when the pre-defined riding event is about to occur after the pre-defined interval. This is ideal for when the network conditions along the route of the rider are stable.

In an alternate embodiment, when the network conditions are erratic along the route of the rider, the control unit 110 is configured to determine each of the pre-defined riding events on the route of the rider based on the origin and destination selected by the rider, and receive/downloading information corresponding to each of the pre-defined riding events before the start of the ride. This means that the receiving/downloading of the information from the external communication device 200 takes place before the start of the ride, that is the primary set of information is received/downloaded from the external communication device 200 and is stored in a memory unit 170 before the start of the ride and displayed at all times, while the secondary set of information is received/downloaded from the external communication device 200 and is stored in the memory unit 170, before the start of the ride and displayed only when the pre-defined riding event is about to occur after the pre-defined interval. This allows for smooth and accurate navigation even when the network conditions are unstable or erratic along the route of the rider.

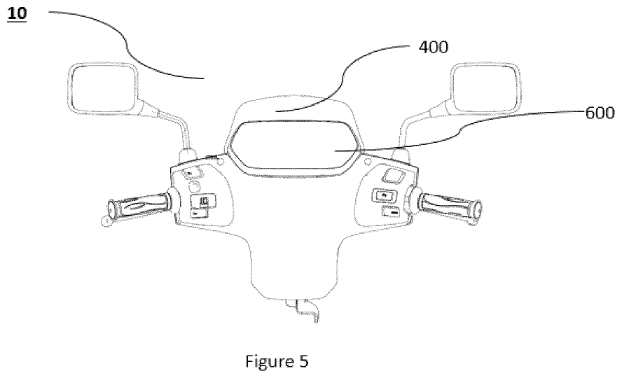

As explained hereinbefore, the display panel of the display module 120 is provided on the vehicle, or the wearable device 300. In an embodiment, the wearable device 300 is worn by the rider on the head and the display panel is provided on a visor of the wearable device 300. In an embodiment as referenced in FIG. 5, the vehicle is a saddle type vehicle 10 and the display panel is provided on an instrument panel 600 on a handlebar of the vehicle 10. Further, the saddle type vehicle 10 is provided with a visor 400 for providing frontal coverage to the display panel. The visor 400 allows for avoidance of glare and exposure of the display panel to wind and damage during riding. Further, in order to accommodate the visor 400 and to prevent the visor 400 from hindering the rear view mirror assembly, the mirror stem in both left and right sides are lengthened, which eliminates the risk of mirror fouling with the visor 400 during assembly and disassembly.

In a further embodiment, the secondary set of information further comprises one or more of an audio feedback to a wearable device such as audio directions, or a visual feedback on a display panel or visor of the wearable device, or a haptic feedback on a handlebar of the vehicle which augments the primary set of information and the secondary set of information being displayed on the display panel.

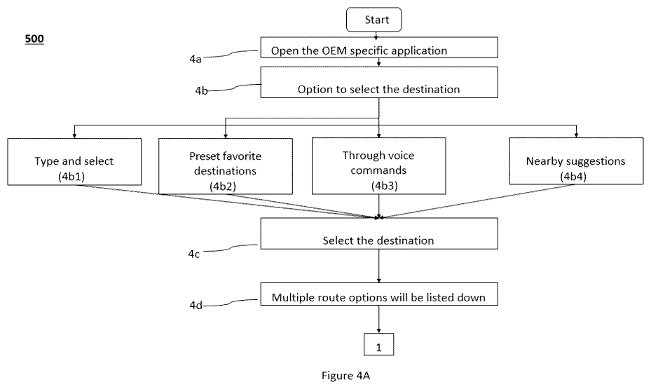

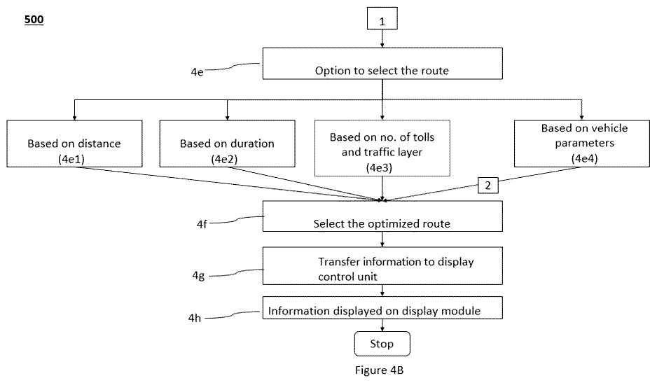

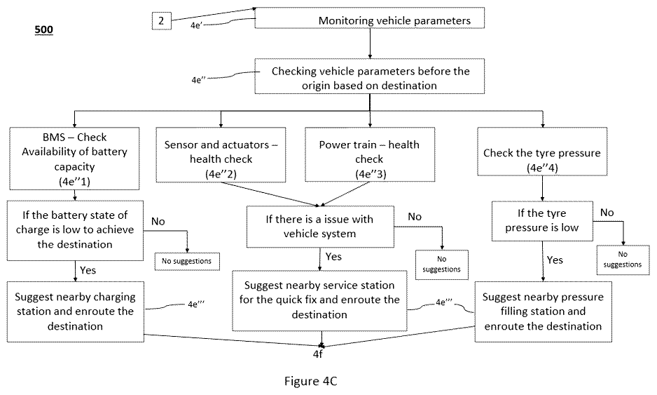

In a further embodiment, as has been referenced in FIGS. 4A, 4B and 4C, the control unit 110 is configured to monitor whether one or more vehicle parameters lie within a pre-defined range corresponding to the origin and destination selected by the rider. The one or more vehicle parameters comprise availability of battery capacity, health of sensors and actuators, health of power train and tyre pressure. In that, if the one or more vehicle parameters do not lie within the pre-defined range, the control unit 110 is configured to suggest one or more solutions enroute the destination selected by the rider. The control unit 110 is capable of optimising the route from origin to destination selected by the rider based on at least distance, duration, and the one or more vehicle parameters.

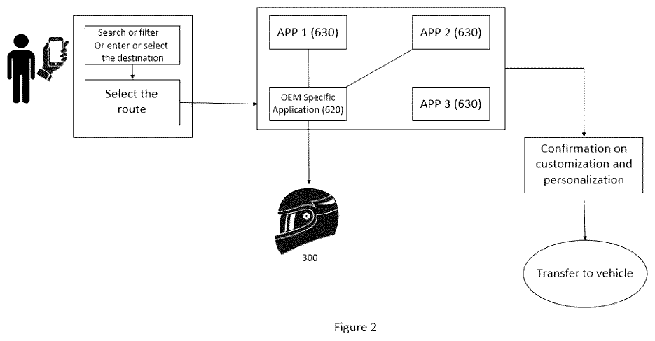

In operation, as referenced in FIG. 2 and FIGS. 4A, 4B and 4C, the rider opens the OEM application 640 on their external communication device 200 to select their destination. The rider is able to select the destination based on their input that they can type in, or on saved favourite destinations or through voice commands or based on nearby suggestions such as stations, malls, or the like. Once the destination is selected, multiple route options are listed down for the rider to choose from. The rider is able to choose an option from the listed routes based on distance, or duration, or based or traffic or tolls or the like, or based on vehicle health that consists of one or more vehicle parameters. In that, the control unit 110 is configured to monitor the one or more vehicle parameters based on the destination, before the start of the ride. The control unit 110 monitors vehicle parameters such as availability of battery capacity, health of actuators and sensors, health of power train and tyre pressure. If all the vehicle parameters lie within a pre-defined range, the optimised route is selected either by the rider or by the rider assist system 100. If the vehicle parameters do not lie within pre-defined range, then the control unit 110 is configured to suggest solutions such as nearby charging station if the battery is low, nearby service station if the tyre pressure is too low, or if there is some issue with the power train or the battery, or the like.

Thereafter, the optimised route is selected by the rider or is selected by the rider assist system 100. Once the optimised route is selected, the primary set of information and the secondary set of information are communicated to the control unit 110 and displayed on the display module 120 as explained hereinbefore.

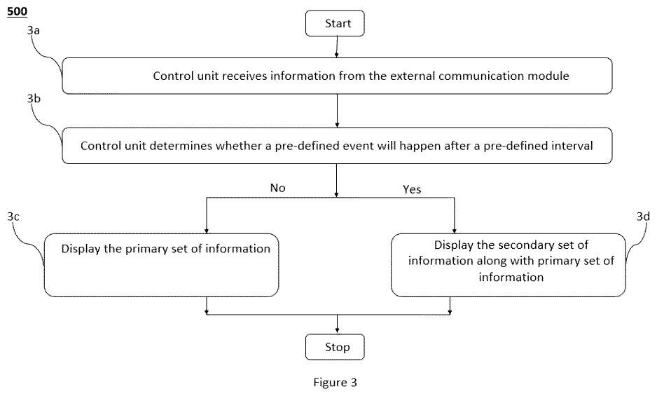

In another aspect, as illustrated in FIG. 3, the present invention relates to a method 500 for assisting a rider while riding a vehicle. The method steps involved in the method 500 are explained as follows. At step 3a, information from an external communication device 200 is received by a control unit 110 through a communication module 130. The external communication device 200 comprises a smart phone or a tablet device capable of being carried by the rider. It is to be understood that the external communication device 200 is equipped with network capabilities to be connected to a map database 640 over a VoLTE, LTE, 3G, or the like. The external communication device 200 is thus capable of downloading data from the map database as per requirement. The external communication device 200 is further equipped with messaging apps 610, OEM specific application 620 which is designed and provided in relation to the vehicle that the rider is riding, and other applications 630 as per requirement. The communication module 130 in communication with the external communication device 200, comprises a wireless interface module 140. The wireless interface module 140 facilitates the communication of the communication module 130 with the external communication device 200 over a wireless network such as Bluetooth, WiFi, or the like. In an embodiment, the information received by the control unit 110 comprises navigation data from the external communication device 200.

At step 3b, whether a pre-defined riding event out of a set of pre-defined riding events will occur after a pre-defined interval, is determined based on the information received from the external communication module 200. In operation, once a rider chooses an origin and a destination, the set of pre-defined riding events comprises of junctions, intersections, flyovers, underpass, exits, or the like that lie between the origin and the destination chosen by the rider. In an embodiment, the pre-defined interval comprises of a pre-defined distance and/or a pre-defined time. Thus, in an embodiment, the method 500 comprises the step of determining whether the pre-defined riding event out of the set of pre-defined riding events will occur after a pre-defined distance. In an alternate embodiment, the method 500 comprises the step of determine whether the pre-defined riding event out of the set of pre-defined riding events will occur after a pre-defined time.

At step 3c, a primary set of information is received from the external communication device 200 and displayed on the display module 120, irrespective of the pre-defined riding event occurring. Thus, in operation, the primary set of information will be received or downloaded from the external communication device 200 and displayed on the display module 120 throughout the route of the rider, and under all riding conditions. If it is determined that the pre-defined riding event will occur after the pre-defined interval, at step 3d, a secondary set of information corresponding to the pre-defined riding event before the pre-defined interval is received from the external communication device 200 and displayed on the display module 120, in addition to the primary set of information. Herein, the secondary set of information has a larger data size than the primary set of information. In an embodiment, the display module 120 has a Thin-Film Transistor (TFT) display panel configured to be provided on the vehicle, or a wearable device 300. In that, the display module 120 being a TFT based module, has no processing capabilities, and thus the rider assist system 100 is provided for the vehicle without requiring an Operating System to facilitate the working of the rider assist system.

In an embodiment, the primary set of information comprises directional arrows to guide the rider for navigating the vehicle through the one or more pre-defined riding events that are along a path of the origin and destination. While, the secondary set of the information comprises full map images corresponding to the pre-defined riding event that is occurring after the pre-defined interval. In operation, once the rider has selected the origin and the destination, along the route, the pictorial arrows are always displayed for navigation during the transit from the origin to the destination. When a pre-defined riding event like a flyover, junction, exit, or the like is about to occur after a pre-defined distance and/or a pre-defined time, the full map images are displayed on the display panel along with the pictorial arrows to allow better and more accurate navigation. As a result, the full map images are only displayed to the rider before the pre-defined riding event is about to occur, thus displaying only necessary information to the rider. This limiting of information to be displayed also allows for the data to be handled without requiring an operating system.

In an embodiment, each of the pre-defined riding events on the route of the rider are determined based on the origin and destination selected by the rider and the secondary set of information corresponding to the specific pre-defined riding event is displayed before the pre-defined interval, in addition to the primary set of information. This means that the receiving of the information from the external communication device 200 takes place in real time along the route of the rider, that is the primary set of information is received/downloaded from the external communication device 200 and displayed at all times, while the secondary set of information is received/downloaded from the external communication device 200 and displayed only when the pre-defined riding event is about to occur after the pre-defined interval. This is ideal for when the network conditions along the route of the rider are stable.

In an alternate embodiment, when the network conditions are erratic along the route of the rider, each of the pre-defined riding events on the route of the rider are determined based on the origin and destination selected by the rider, and information is received corresponding to each of the pre-defined riding events before the start of the ride. This means that the receiving of the information from the external communication device 200 takes place before the start of the ride itself, that is the primary set of information is received/downloaded from the external communication device 200 before the start of the ride and displayed at all times, while the secondary set of information is received/downloaded from the external communication device 200 before the start of the ride and displayed only when the pre-defined riding event is about to occur after the pre-defined interval. This allows for smooth and accurate navigation even when the network conditions are unstable or erratic along the route of the rider.

In a further embodiment, the secondary set of information further has one or more of an audio feedback to a wearable device such as audio directions, or a visual feedback on a display panel or visor of the wearable device, or a haptic feedback on a handlebar of the vehicle which augments the primary set of information and the secondary set of information being displayed on the display panel.

In a further embodiment, one or more vehicle parameters are monitored as to whether one or more vehicle parameters lie within a pre-defined range corresponding to the origin and destination selected by the rider. The one or more vehicle parameters comprise availability of battery capacity, health of sensors and actuators, health of power train and tyre pressure. In that, if the one or more vehicle parameters do not lie within the pre-defined range, one or more solutions are suggested enroute the destination selected by the rider. In a further embodiment, the method 500 comprises the step of optimising the route from origin to destination selected by the rider based on at least distance, duration, and the one or more vehicle parameters.

In operation, as referenced in method steps illustrated in FIGS. 4A, 4B and 4C, at step 4a, the rider opens the OEM application 640 on their external communication device 200 to select their destination. At step 4b, the rider is able to select the destination based on their input that they can type in as in step 4b1, or on saved favourite destinations as in step 4b2, through voice commands as in step 4b3 or based on nearby suggestions such as stations, malls or the like as in step 4b4. Once the destination is selected at step 4c; at step 4d, multiple route options are listed down for the rider to choose from. At step 4e, the rider is able to choose an option from the listed routes based on distance as in step 4e1, or duration as in step 4e2, or based or traffic or tolls or the like as in step 4e3, or based on vehicle health as in step 4e4 that consists of one or more vehicle parameters. In that, at step 4e′ and 4e″, one or more vehicle parameters are monitored based on the destination, before the start of the ride. The vehicle parameters such as availability of battery capacity as in step 4e″1, health of actuators and sensors as in step 4e″2, health of power train as in step 4e″3 and tyre pressure as in step 4e″4 are monitored. If all the vehicle parameters lie within a pre-defined range, the optimised route is selected either by the rider or by the rider assist system 100 at step 4f. If the vehicle parameters do not lie within pre-defined range, in furtherance of step 4e′ and 4e″, at step 4e″′, solutions are suggested such as nearby charging station if the battery is low, nearby service station if the tyre pressure is too low, or if there is some issue with the power train or the battery or the like.

Thereafter, at step 4f, the optimised route is selected by the rider or is selected by the rider assist system 100. Once the optimised route is selected, at step 4gthe primary set of information and the secondary set of information are communicated to the control unit 110, and at step 4h, displayed on the display module 120 as explained hereinbefore.

Advantageously, the present invention provides for a rider assist system and a method thereof in which the rider assist system is provided with assistance or route navigation data without usage of any operating system. This allows for a simple cost effective system and method to be employed in vehicles, which is not only cheaper, but is also less intensive in terms of number of parts and difficulty in configuration. Further, the present invention ensures that the data required for navigation or route assistance is only downloaded or received and displayed as per requirement before the pre-defined riding event, which allows for usage of less data and prevents presentation of unnecessary information to the rider and avoids clutter if information on the instrument cluster of the vehicle. Since, the present invention does not use an OS, the system requires less amount of current in comparison to OS based system, which is critical in case of electric and hybrid electric vehicles.

Further, the present invention allows for the route assistance to be provided in conditions of stable networks as well as erratic or unstable network conditions.

Furthermore, provision of a display module with a display panel on the vehicle or on the wearable device ensures better rider comfort and ergonomics, as the requirement of an external device to held by the rider or to be mounted on the vehicle is eliminated.

The claimed steps as discussed above are not routine, conventional, or well understood in the art, as the claimed steps enable the following solutions to the existing problems in conventional technologies.

While the present invention has been described with respect to certain embodiments, it will be apparent to those skilled in the art that various changes and modification may be made without departing from the scope of the invention as defined in the following claims.

1-39. (canceled)

40. A rider assist system for a vehicle, comprising:
a communication module configured to be in communication with an external communication device; and
a display module configured to display information to a rider of the vehicle, wherein the display module is in communication with a control unit, and
the control unit is configured to:
receive information from the external communication device through the communication module,
determine, based on the information received, whether a pre-defined riding event out of a set of pre-defined riding events occurs after a pre-defined interval,
receive from the external communication device and display on the display module, a primary set of information irrespective of the pre-defined riding event occurring, and
receive from the external communication device and display on the display module, a secondary set of information corresponding to the pre-defined riding event before the pre-defined interval, in addition to the primary set of information, when it is determined that the pre-defined riding event occurs after the pre-defined interval, wherein the secondary set of information has a larger data size than the primary set of information.

41. The rider assist system as claimed in claim 40, wherein the information received by the control unit comprises navigation data from the external communication device.

42. The rider assist system as claimed in claim 40, wherein
the pre-defined interval comprises a pre-defined distance and/or a pre-defined time,
the control unit is configured to determine whether the pre-defined riding event out of the set of pre-defined riding events occurs after a pre-defined distance, and
the control unit is configured to determine whether the pre-defined riding event out of the set of pre-defined riding events occurs after a pre-defined time.

43. The rider assist system as claimed in claim 40, wherein the control unit is configured to determine each of the pre-defined riding events on a route of the rider based on an origin and a destination selected by the rider and at least one of:
display the secondary set of information corresponding to a specific pre-defined riding event before the pre-defined interval, in addition to the primary set of information, and
receive information corresponding to each of the pre-defined riding events before a start of a ride.

44. The rider assist system as claimed in claim 40, wherein the secondary set of information comprises full map images corresponding to the pre-defined riding event that is occurring after the pre-defined interval.

45. The rider assist system as claimed in claim 40, wherein the primary set of information comprises directional arrows to guide the rider for navigating the vehicle through the one or more pre-defined riding events that are along a path of an origin and a destination.

46. The rider assist system as claimed in claim 40, wherein
the vehicle is a saddle type vehicle,
a display panel is provided on an instrument panel on a handlebar of the vehicle, and
the saddle type vehicle is provided with a visor for providing frontal coverage to the display panel.

47. The rider assist system as claimed in claim 40, wherein the secondary set of information further comprises one or more of an audio feedback to a wearable device, a visual feedback on a display panel or visor of the wearable device, or a haptic feedback on a handlebar of the vehicle.

48. The rider assist system as claimed in claim 40, wherein
the control unit is configured to monitor whether one or more vehicle parameters lie within a pre-defined range corresponding to an origin and a destination selected by the rider,
when the one or more vehicle parameters do not lie within the pre-defined range, the control unit is configured to suggest one or more solutions enroute the destination selected by the rider.

49. The rider assist system as claimed in claim 48, wherein
the one or more vehicle parameters comprise availability of battery capacity, health of sensors and actuators, health of power train and tyre pressure, and
the control unit is configured to optimise a route from an origin to a destination selected by the rider based on at least distance, duration, and the one or more vehicle parameters.

50. A method for assisting a rider for a vehicle, the method comprising the steps of:
receiving, by a control unit, information from an external communication device through a communication module;
determining, based on the information received, whether a pre-defined riding event out of a set of pre-defined riding events occurs after a pre-defined interval;
receiving from the external communication device and displaying on a display module, a primary set of information irrespective of the pre-defined riding event occurring; and
receiving from the external communication device and displaying on the display module, a secondary set of information corresponding to the pre-defined riding event before the pre-defined interval, in addition to the primary set of information, when it is determined that the pre-defined riding event occurs after the pre-defined interval, wherein the secondary set of information has a larger data size than the primary set of information.

51. The method as claimed in claim 50, wherein
the information received by the control unit comprises navigation data from the external communication device,
the pre-defined interval comprises of a pre-defined distance and/or a pre-defined time, and
the step of determining whether the pre-defined riding event out of the set of pre-defined riding events occurs after at least one of a pre-defined distance or a pre-defined time.

52. The method as claimed in claim 50, wherein each of the pre-defined riding events on a route of the rider are determined based on an origin and a destination selected by the rider, and at least one of:
the secondary set of information corresponding to a specific pre-defined riding event before the pre-defined interval, in addition to the primary set of information is displayed, and
information received corresponding to each of the pre-defined riding events before start of a ride.

53. The method as claimed in claim 50, comprising the step of monitoring whether
one or more vehicle parameters lie within a pre-defined range corresponding to an origin and a destination selected by the rider,
when the one or more vehicle parameters do not lie within the pre-defined range, then suggesting one or more solutions enroute the destination selected by the rider.

54. A display module for a rider assist system, the display module comprising:
a Thin-Film Transistor display panel configured for displaying data to a rider; and
the display module being in communication with a control unit, wherein
the control unit is configured to:
receive information from an external communication device through a communication module,
determine, based on the information received, that whether a pre-defined riding event out of a set of pre-defined riding events occurs after a pre-defined interval,
receive from the external communication device and display on the display panel, a primary set of information irrespective of the pre-defined riding event occurring, and
receive from the external communication device and display on the display panel, a secondary set of information corresponding to the pre-defined riding event before the pre-defined interval, in addition to the primary set of information, when it is determined that the pre-defined riding event occurs after the pre-defined interval, wherein the secondary set of information has a larger data size than the primary set of information.
